(19) United States
(12) Patent Application Publication
(10) Pub. No.: US 2014/0248435 A1
(43) Pub. Date: Sep. 4, 2014

(54) 2-COMPONENT POLYURETHANE COATING ON FIBER CEMENT

(71) Applicant: FIBRECEM HOLDING AG, Niederumen (CH)

(72) Inventors: Mathias Hämmerli, Niederumen (CH); Paul Szegedy, Wadenswil (CH); Gerald Trabesinger, Kaltbrunn (CH); Klemens Bösch, Reichenburg (CH)

(73) Assignee: FIBRECEM HOLDING AG, Niederurnen (CH)

(21) Appl. No.: 14/348,681

(22) PCT Filed: Sep. 20, 2012
(86) PCT No.: PCT/EP2012/068549

§ 371 Date: Mar. 31, 2014

(30) Foreign Application Priority Data
Oct. 6, 2011 (CH) 01634/11

(51) Int. Cl. C09D 133/08; B05D 3/02

(52) U.S. Cl. CPC C09D 133/08; B05D 3/0218; C08K 5/3492
USPC 427/314; 524/507; 524/100

(57) ABSTRACT

For the coating of a substrate, at least in part of mineral materials, a composition contains a formulation having at least two components. The first component is a base having at least one OH-functionalized binding agent, such as at least one polyacrylate having a styrene content of approx. ≦30%. The second component, contains at least one aliphatic isocyanate or a polymer thereof, and at least one filler substance has an organic base, such as polyurethane or polymethyl methacrylate.

The present invention relates to a composition for a coating for a substrate, consisting at least in part of mineral materials, according to the preamble of claim 1.

Specifically, the present invention relates to the formulation and application of a weatherproof coating for fiber cement products. In particular, this concerns a two-component polyurethane coating having an aqueous base, referred to in the following as 2K-PUR, which is applied, by way of example, to a fiber cement sheet, and hardened in an industrial production line. For the use of a fiber cement sheet of this type, an extremely weatherproof coating is necessary. In particular, the coating must exhibit a very high long-term durability with respect to UV radiation, heat, freezing and thawing cycles, and the effects of water and moisture. Moreover, the coating must be resilient to the high alkalinity of the fiber cement, and suppress its tendency to develop lime deposits. Furthermore, the coating must satisfy the aesthetic demands of the client, in that it is matt, and at the same time, exhibits a high degree of transparency, such that the fiber cement aspect valued by the client is readily visible on the surface.

The acrylate coating normally applied to a fiber cement sheet has some disadvantages, independently of whether it is pre-treated with a primer, likewise usually having an acrylic base and/or hydrophobizing, e.g. by means of hydrophobizing silanes or siloxanes, or mixtures thereof. One of the disadvantages is that the acrylate coating is thermoplastic, meaning that it becomes soft under the effects of temperature changes. This can result in adhesion between the individual sheets in a stack of fiber cement sheets subjected to the effects of changes in temperature (e.g. at a construction site, exposed to extreme sunshine, or during transport in hot climates). If sheets of foil are inserted between the individual sheets to prevent adhesion, it is possible that the pattern on the foil may become imprinted in the coating.

The acrylate coating also suffers a lack of mechanical stability, such as diminished firmness, making it more difficult to work with in construction applications. Another disadvantage is that the coating is not resistant to graffiti. Sprays and paints can no longer be removed after a graffiti attack, because it is frequently the case that they must be cleaned using a solvent, which is not possible with a conventional coating. A thermoplastic coating, for example, would also be removed by the solvent.

EP 0 192 627 B1 describes a two-component polyurethane coating for construction materials, including asbestos cement, among other things. This polyurethane coating, however, has a solvent base, and is therefore ecologically questionable, and for use in an industrial coating line, can only be used if a great deal of effort has been made to protect against explosions. In particular, the drying at high temperatures can only be carried out with great difficulty with a solvent-containing coating system. The drying at high temperatures is, however, absolutely necessary for the weather and graffiti resistance, because at room temperature, or lower temperatures, the integration reaction of the two components can only run incompletely. The consequence is a shortcoming in weather and graffiti resistance, as is depicted below in table 3. The legislation in Switzerland (VOC steering tax) and the EU tend to eliminate or reduce the possibility of large-scale industrial applications of solvents in the future.

EP 1 914 215 describes a coating that can be hardened with UV radiation, having groups containing isocyanate on a chromophoric acrylate base. The disadvantage of this invention is that the degree of matting can only be achieved with great difficulty, by means of applying a structured polypropylene foil. Furthermore, the additional coating that can be hardened with UV radiation described in the patent must be applied to a fiber cement sheet that has already been provided with an acrylate coating. These two points, the difficult matting and the additional coating that is to be applied, that can be hardened under UV radiation, make the product more expensive, however.

U.S. Pat. No. 5,308,912 and EP 0,524,085 describe an aqueous 2K-PUR formulation for wood and other substrates, including, among others, a mineral-based substrate as well. In particular, the addition of a polyether polyol for increasing the degree of gloss is claimed.

One of the disadvantages of these two patents is that the lowest degree of gloss, desired by the client, cannot be achieved in this manner for coatings on fiber cement.

Another disadvantage with the two aforementioned patents is that, for the required very high weather resistance, it is not sufficient to select only a polyacrylate polyol/polyisocyanate binding agent system for a 2K-PUR coating on fiber cement.

Patent DE 102007059090 A1 describes a polymer mixture, wherein a polyacrylate polyol/polyisocyanate mixture is mentioned for decorative surfaces in automobile interiors. As the matting agent, a polyurethane dispersion is proposed.

A disadvantage of this invention is that with the polyacrylate polyol/polyisocyanate mixture described in general, the long-term weather resistance corresponding to the client demands cannot be achieved on the highly alkaline fiber cement for use in exterior regions. WO97/45475 also describes a two-component polyurethane formulation having an aqueous base, and having a high degree of gloss, which can, aside from other substrates, also be applied to mineral-based substrates. In this patent as well, in a non-specific list, a polyacrylate and a styrene acrylate are specified as possible binding agents.

The disadvantages of this formulation are the same as those with U.S. Pat. No. 5,308,912 and EP 0524085: the coating has a high degree of gloss, which is not desired by the client. The very good long-term stability with the suitable binding agent and hardener combination, together with the suitable filler materials and UV absorbers, is not the subject matter of the invention in patent WO97/45475. As such, a hydrophobic polyisocyanate hardener, on page 2, lines 17-21, is actually regarded as unsuitable, because it is difficult to incorporate in the aqueous system.

It is one objective of the present invention to replace the typical acrylate coating on fiber cement sheets with a two-component coating, which overcomes the aforementioned disadvantages.

In general, the objective of the present invention is thus to propose a composition for the coating of a substrate consisting at least in part of mineral substances, which exhibits none of the specified disadvantages, such as, for example, a two-component polyurethane coating that is adhesion and scratch resistant, suitable for anti-graffiti measures, and fulfills all of the requirements for a weather resistant coating for a mineral substrate such as, in particular, fiber cement sheets. The objective also consists of enabling bonding without difficulty and eliminating or nearly eliminating optical changes due to UV light effects, freezing and thawing cycles, warm water and moisture effects, as well as permeation from water via the edges.

According to the invention, the objectives are achieved by means of a composition for the coating of a substrate, consisting at least in part of mineral substances, according to the wording of claim 1.

Thus, the formulation according to the invention exhibits both a high degree of weather resistance on the alkaline fiber cement and at the same time fulfills the high demands of the client with respect to the aesthetic appearance.

As such, the coating according to the invention is very matt, while at the same time exhibiting a high degree of transparency, such that the characteristic fiber image of the fiber cement sheet is realized to an optimal extent.

It is proposed that the composition contains at least one formulation having at least two components, wherein the first component consists of a binding agent having at least an OH-functionalized base, such as at least one polyacrylate with a styrene content ≦30%, and the second component contains at least one aliphatic isocyanate, or a polymer thereof, and that furthermore, the formulation contains at least one filler material having an organic base, such as polyurethane or polymethyl methacrylate. The first component can be a dispersion of one of the polymers in the following list, such as polyacrylate, styrene acrylate, and/or mixtures thereof.

According to one embodiment variation, mixtures of polyacrylate are provided, wherein one binding agent component exhibits a styrene content of ≦30%, another binding agent component exhibits a styrene content of ≦5%, and/or another component, in turn, is an OH-functionalized pure acrylate.

According to one example, the present invention functions with OH contents of 0.5% -20%, preferably 1% -10%. Thus, a first polyacrylate can have an OH portion of 2%, and the one other binding agent component can have an OH portion of 5.0%, for example.

The coating composition according to the present invention can, aside from the first component, or the binding agent, respectively, contain pigments and other raw materials and auxiliary materials, such as fillers, crosslinking and dispersing additives, emulsifiers, rheology additives, wetting and flow additives, defoaming agents, storage and film preservatives, wax dispersions, hydrophobing agents, biocides, UV protection agents, fibers, solvents, film-forming agents and other raw materials.

It is also the subject matter of the present invention that suitable organic filler materials, such as filler materials having a polyurethane or polyacrylate base, for example, are added, either alone or in combination with inorganic filler materials. In the two patents U.S. Pat. No. 5,308,912 and EP 0 542 085, for example, no filler materials are mentioned. Formulations 1 and 2 according to the following table 2 are formulations having a typical inorganic filler material base. These formulations exhibit, however, aside from an excessive gloss in the aging tests, unacceptable bubble formation and strong fading of the coating in the moisture test. An unacceptable fading of the coating also occurred after the UV/moisture exposure cycles in the QUV test.

Another claim of the present invention is the use of a UV absorber having a triazine type base. This is only superficially specified, as “additives conventionally used,” in the two aforementioned patents.

In patent EP 0 192 627 B1 as well, no reference is made to the organic filler materials according to the invention. As such, in column 3, line 54, a matting agent having a silicic acid (SiO₂) or magnesium metasilicate base is proposed. The first matting agent has been shown, however, to be detrimental regarding the long-term stability, and the second leads to a cloudiness in the coating, such that the desired fiber image of the sheet is barely, or even not at all, visible.

In addition, in column 4, lines 37-43, it is proposed, for obtaining the low gloss, that the addition of hardener (component B) to component A be reduced in quantity. By this means, however, it is still not possible to obtain the low gloss currently demanded by clients.

As filler material, those having an organic base, for example, are suitable, such as filler materials having a polymethyl methacrylate or polyurethane base, which, of course, can also be modified for purposes of better stability. According to one embodiment variation, it is proposed that numerous filler materials be mixed together, exhibiting different grain sizes for example, in a range of 0.1-100 μm for example, preferably between 1 μm and 75 μm. According to one embodiment variation, it is proposed that a mixture of 60% -95%, having grain sizes of ≦28 μm, be used, while the rest has a grain size in the range of 28 μm-40 μm. As a matter of course, larger grain sizes can also be used, wherein grain sizes of ≦75 μm amount to less than 1%. This is merely an example, and other mixtures are, of course, possible.

Other possible filler materials are inorganic fillers, such as silicates, carbonates, aluminosilicates, such as dolomite, talc, calcite, etc. Mixtures of inorganic and organic filler materials are also possible.

Typical pigments are metal oxides, such as titanium dioxide, iron oxide, spinel pigments, titanates, or other pigments, including organic pigments, such as phthalocyanine, for example.

Suitable UV absorbers comprise the typical substance classes such as oxalanilides, triazines, triazoles, benzotriazoles, and/or benzophenones and/or inorganic UV absorbers, such as those having a base of transparent, modified titanium dioxide, zinc oxide, cerium oxide or suchlike. These UV absorber classes are ideally supplemented with free-radical interceptors, e.g. the substance classes of sterically hindered amines (HALS compounds). The pure substances, as well as in the form of aqueous dispersions or emulsions, such as those offered by Ciba as a Tinuvin type, can be used. Suitable quantities for supplements as UV absorbers and free radical interceptors are in the range of 0.1-5% by weight, most suitable being in the range of 0.1-2% by weight, with respect to the pure substance quantity.

According to another embodiment variant, it is proposed that the formulation contains a hardening component as the second component, exhibiting single, or as a mixture, different oligomers/polymers of aliphatic isocyanates, such as, e.g. hexamethylene di-isocyanates or isophorone di-isocyanate, or any polyisocyanates having aliphatic, cycloaliphatic, araliphatic bonded, free isocyanate groups, which, optionally, can be modified with ethylene oxide and/or propylene oxide.

The formulation according to the invention has been developed for mineral substrates, in particular for fiber cement. For this, the coating must be stable at a high alkali pH value of up to 14 in a freshly produced fiber cement sheet, which is not the case with decorative surfaces in the interior of an automobile, as described, for example, in patent DE 102007059090. Furthermore, it must suppress the tendency of fiber cement to develop lime deposits, and exhibit a very long-term stability when exposed to any weather effects, in particular UV radiation, freezing/thawing cycles and the effects of moisture. This, however, is not achieved with all polymer/polyisocyanate mixtures.

These requirements are fulfilled in that, for example, a mixture of polyacrylate polyols is used, from which one of the polyacrylate polyols exhibits a maximum styrene content of 30%, and the second has a substantially lower content of 5% or less. By this means, one obtains the necessary hydrophobicity for the 2K-PUR film, resulting in an excellent weather resistance (see table 2 below). At the same time, through the mixing with the second binding agent, one prevents a yellowing due to the effect of sunlight, which can otherwise occur with the incorrect use of styrene acrylates. On the hardener side as well, a combination of a more hydrophilic substance with a hydrophobic hardener is used, for example, in order to obtain the high degree of stability. Both the mixture of two suitable polyacrylate polyols, as well as the mixture of two suitable polyisocyanate hardeners, are not, however, the subject matter of patent DE 102007059090 A1. Furthermore, the grain sizes of the polyurethane and/or polyacrylate filler that are used should be fully balanced out, in order to achieve, simultaneously, the low gloss and the high transparency, in addition to the high degree of weather resistance. Also not the subject matter of the invention in patent DE 102007059090 A1 is that it is advantageous for the 2K-PUR coating to be subjected to a thermal treatment of, e.g. at least 20 minutes at 50-110° C. after application, as well as 100-140 minutes at 65° C.-90° C. The complete reaction of the OH-functionalized acrylate polymers with the isocyanate components first occurs as a result of a thermal treatment, resulting in a better weather and graffiti resistance (see table 3 below).

Other modifications are also possible, such as the incorporation of functional groups, for example, such as 3-(cyclohexylamino)-1-propanesulfonic acid, for example, or other groups. Hardeners of this type are best known as so-called Desmodur or Bayhydur from the company Bayer, or Basonat from the company BASF. It is preferred that a mixture of hardeners be used, wherein one hardener is more hydrophilic, and is responsible for a uniform hardening, and the second hardener is hydrophobic, and thus provides for an improved hydrophobicity, and hence water resistance of the film. The preferred isocyanate content of the hardener mixture is between 10% and 40%, more preferably 15% and 25%. Ideally, the two hardeners are diluted in a solvent that can be used with isocyanate, in order to adapt the viscosity to the viscosity of the binding agent component A, and thus make it more mixable. Solvents that can be used with isocyanates are solvents that do not react with the isocyanate groups in the hardener. This means that the solvents contain no hydroxy-, amino-, thiol-, and acid groups, or other groups that react with isocyanate. It is understood that the proportions of the individual hardeners and the solvent can be varied over the entire range of 0% -100%, and individual hardeners can also be omitted, or new hardeners can be added. Likewise, the solvent can be varied in terms of its proportion, and fundamentally, replaced with any solvent that is compatible with isocyanate. An example of a suitable hardener mixture consists of approx. 40% of the hydrophobic hardener Desmodur N-3600 (Bayer) and approx. 40% of the hydrophilic hardener Bayhydur 304 (Bayer), diluted with approx. 20% of the solvent Jeffsol PC (propylene carbonate, manufactured by Huntsman).

According to another embodiment variant of the present invention, it is proposed that the components of the formulation are mixed, for example, such that the isocyanate concentration of the hardener component, referred to as component B, to the hydroxyl concentration of the first component, referred to as component A, in the molar ratio of [NCO]:[OH] is between 1:1 and 5:1, for example, 1.5:1. In terms of mass and volume, the mixture ratio for the components A and B can fluctuate between A:B=0.1:1 to 10:1. According to a special embodiment example, the mixture ratio for A:B lies between 4:1 and 8:1, preferably, for example, at 6:1.

The mixture can also be diluted with water or other solvents, in order to decrease the viscosity. By way of example, additive quantities fluctuate in their ratio from 0-100% by weight, in relation to the mixture of the two components A and B. An addition of water in the range of 10-50% by weight, for example, is suitable, as is the case, for example, with an addition of water amounting to 25% by weight.

According to the present invention, it is furthermore proposed that the two components of the formulation, described above, or the coating composition, respectively, are dosed via separate containers, by means of a mixture and dosage assembly, in a ratio as described above, and are homogenously mixed in a suitable mixer. Suitable application quantities in the form of a wet film amount to 50-500 g/m², such as 100-250 g/m². The dry layer thickness can be between 10 and 100 μm, e.g. 30-80 μm.

With a suitable formulation and a suitable mixer and dosing assembly, it is possible to obtain a low gloss, and the incorporation of the hydrophobic polyisocyanate hardener contributes to the long-term durability of the present invention. As such, the hydrophobic polyisocyanate hardener increases the resistance to aging, as is shown by the comparison of the formulations 1 and 2 in table 2 (without hydrophobic polyisocyanate hardener) with the formulations 3 and 4 (with hydrophobic polyisocyanate hardener). The coating no longer forms bubbles, there is no discoloration, e.g. through fading, and the UV resistance is decisively improved.

After the two components of the coating composition have been applied to the fiber cement sheet, with a surface temperature, by way of example, of 25° C.-80° C., and, as is the case with the 2K-PUR coating, for example, on a primed or not primed fiber cement sheet, for example, the coating subsequently reacts thoroughly by means of a drier for 10 minutes-10 hours, for example, over 100 minutes, at 20° C.-120° C., at 80° C., for example. The crosslinking reaction between the two components A and B is then complete, as is shown in FIG. 1, having the spectrum B. The complete crosslinking reaction is a prerequisite for a very good weather and graffiti resistance, as shown in table 3. The 2K-PUR coating can be colored to any color by means of pigments, whether this be opaque, transparent or translucent. The formulation and the corresponding application result in a coating that is very weather resistant with respect to maintaining its color, surface aspects (no changes, or limited changes to the coating) and bonding, and the high aesthetic demands of the client, such as low gloss and a uniform appearance.

### EXAMPLES

In the following, two exemplary recipes are described, each of which has a coating composition according to the present invention:

### Recipe 1: Formulation for the 2K-PUR Glaze

| | | |
|---|---|---|
| Raw Materials | Quantity | %-proportion |

| | | | |
|---|---|---|---|
| (Component A): | | | |
| Bayhydrol XP-2695 | 300 | g | 32.38% |
| Bayhydrol XP-2427 | 130 | g | 14.031% |
| Decosoft 18, transparent | 50 | g | 5.397% |
| Decosoft 15, tranparent | 50 | g | 5.397% |
| Tinuvin 123-DW | 18 | g | 1.943% |
| Tinuvin 400-DW | 53 | g | 5.720% |
| Water | 190 | g | 20.5% |
| Div. Additive, filler material, | 135.5 | g | 14.625% |
| with or without Pigments | | | |
| TOTAL | 926.5 | g | 100% |
| Hardener Component B | | | |
| Desmodur N 3600 | 50 | g | 40% |
| Bayhydur 304 | 50 | g | 40% |
| Propylene carbonate | 25 | g | 20% |
| TOTAL | 125 | g | 100% |

### Production of Component A:

Additives such as wetting agents, defoaming agents, fungicides, algaecides, are mixed in the water that has been provided, and dispersed with the two filler materials Decosoft 15 and Decosoft 18, while stirring vigorously, until a temperature of approx. 60° C. has been reached.

Subsequently, with constant stirring and further addition of water, the two Bayhydrol binding agent components are added, together with Tinuvin 123-DW and Tinuvin 400-DW. The filming agent butyl glycol is slowly added, by drops, and lastly, water is added, in order to obtain the desired viscosity.

### Production of the Hardener Component B:

The two hardeners Desmodur N3600 and Bayhydur 304 are dissolved in an inert atmosphere in propylene carbonate and sealed in an airtight container.

Processing of the Two Components A and B:

The two components are processed with a 2K (two component) mixing and dosing assembly, wherein components A and B are mixed in a ratio of 6:1. In order to produce an adequate spray viscosity, for purposes of an attractive application, the mixture of A and B is diluted with 25% water.

Recipe 2: 2K-PUR Mixed Color with Pigments:

| | | |
|---|---|---|
| Raw Materials | Quantity | %-proportion |

| | | | |
|---|---|---|---|
| Component A: | | | |
| Bayhydrol XP-2695 | 130 | g | 29.160% |
| Bayhydrol XP-2427 | 300 | g | 12.636% |
| Decosoft 18, transparent | 50 | g | 4.860% |
| Decosoft 15, tranparent | 50 | g | 4.860% |
| Tinuvin 123-DW | 18 | g | 1.750% |
| Tinuvin 400-DW | 53 | g | 5.152% |
| Water | 190 | g | 18.468% |
| Div. additives, fillers, pigment | 237.8 | g | 23.114%% |
| TOTAL | 102.8 | g | 100% |

### Component B: Analogous to Recipe 1.

### Production of Component A Binding Agent:

Additives, such as wetting agents, defoaming agents, fungicides, and algaecides, are mixed in the water provided, and dispersed while stifling vigorously with the two filler materials Decosoft 15 and Decosoft 18, until a temperature of approx. 60° C. has been reached.

Subsequently the two Bayhydrol binding agent components are added while stirring constantly and adding water, together with Tinuvin 123-DW and Tinuvin 400-DW. The filming agent butyl glycol is added slowly, by drops, and lastly, water is added, in order to obtain the desired viscosity.

The processing in production occurs in a manner analogous to recipe 1, wherein the mixture ratio of component A to component B is again selected at 6:1. Again, a 25% dilution with water occurs.

### Legend:

Bayhydrol binding agent from BAYER, Leverkusen, Germany:
Bayhydrol XP-2695 acrylate binding agent
Bayhydrol XP-2427 hydrophobic styrene acrylate binding agent
   Desmodur hardener from BAYER, Leverkusen, Germany:
Desmodur N 3600 aliphatic isocyanate hardener having a hexamethylene di-isocyanate base, hydrophobic
   Bayhydur hardener from BAYER, Leverkusen, Germany:
Bayhydur 304 aliphatic isocyanate hardener having a polyether allophanate modified hexamethylene di-isocyanate base
   Decosoft polyurethane filler from the company Microchem, Erlenbach, Switzerland:
Decosoft 15 transparent, with an average grain size of 15 μm.
Decosoft 18, transparent, with an average grain size of 18 μm.
   Tinuvin additives from the company Ciba Spezialitaten AG, Basel, Switzerland:
Tinuvin 123-DW: free-radical interceptor
Tinuvin 400-DW UV absorber having an N-OR type triazine.

The use of organic fillers, in particular, such as the combination given in the two recipes 1 and 2, of Decosoft 15 and Decosoft 18, results in a matt coating, simultaneously having a high degree of transparency and that can be readily processed in the coating line.

In addition, the combination of the two Bayhydrol binding agent components, the use of the two organic filler materials, and the combination of the two hardeners in the second component, results in a very good weather resistance, for example, on fiber cement. Based on the following tables, a comparison with acrylate coatings and typical 2K-PUR systems available on the market is shown (table 1) and the effects of the binding agent mixtures, the hardener mixture, and the use of organic fillers, on the aging resistance and the gloss is shown (table 2). Likewise, the importance of the complete hardening by means of thermal effects is also shown (FIG. 1 and table 3).

TABLE 1
comparison of different coating types
(all examples on anthracite sheets)

| | | | Anti-graffiti |
|---|---|---|---|
| | | | coating having |
| | | Typical | an aqueous 2K- |
| | 2K-PUR | acrylate | PUR system |
| | of the | coating | base, typical |
| | present | for fiber | marketplace |
| Test | invention | cement | example |
| Adhesion test(RS-VS) | 0-1 | 5 | — |
| (adhesion of | | (Surface | |
| the surfaces) | | destroyed) | |
| Scratch resistance | 1 | 4 | — |
| Anti-graffiti behavior | 0-1 | 5 | 1 |
| Freezing/thawing cycle | 0-1 | 0-1 | 5B |
| (bonding according to | | | |
| stripping test) | | | |
| Moisture test (bonding | 0-1 | 0-1 | 3B |
| according to | | | |
| stripping test) | | | |
| 1 year outdoor exposure | 0 | 0 | 5B |
| (optical evaluation) | | | (after |
| | | | 6 months) |

0 = excellent, 1 = very good, 2 = good, 3 = moderate, 4 = poor, 5 = very poor
B = bubble formation
RS-VS = back surface to front surface

TABLE 2
Comparison of different 2K-PUR formulations

| | all 2K-PUR formulations tested | | | |
|---|---|---|---|---|
| | on primed, anthracite-colored | | | |
| Substrate | fiber cement sheets | | | |
| Formula | 1 | 2 | 3 | 4 |
| Bayhydrol XP-2695 (binding agent 1) | 42.8% | 29.8% | 28.8% | 28.5% |
| Bayhydrol XP-2427 (binding agent2) | | 12.9% | 12.5% | 12.4% |
| Bayhydur 304 (hardener 1) | 9.9% | 9.9% | 4.8% | 4.8% |
| Desmodur N 3600 (hardener 2) | | | 4.8% | 4.8% |
| Plastorit P0000 (inorganic filler) | 12.0% | 12.4% | 6.0% | 1.0% |
| Decosoft 15 (organic filler) | | | 6.0% | 4.8% |
| Decosoft 18 (organic filler) | | | | 4.8% |
| Gloss degree 85° (according to ISO 2813) | 24.1% | 20.2% | 8.7 +/− 0.8% | 3.8 +/− 0.8% |
| ΔE according to 2000 hours QUV | — | 5.80 | 2.87 | 1.69 |
| ΔE according to 4000 QUV | — | — | 5.80 | 2.09 |
| Stripping 0-Probe | 0 | 1 | 0 | 0 |
| Warm water test | 3B | 3B | 1 | 0-1 |
| Stripping according to warm water test | 1 | 1 | 0 | 0 |
| Moisture test | 4V | 3V | 1 | 0-1 |
| Stripping according to moisture test | 1 | 1 | 0 | 0 |
| Freezing test | 5B | 2V | 1 | 0-1 |
| Stripping according to freezing test | 1 | 1 | 0 | 0 |

Evaluation Scale:
0 = excellent, 1 = very good, 2 = good, 3 = moderate, 4 = poor, 5 = very poor
V = discoloration, B = bubble formation

### Commentary:

All tests were carried out on an anthracite colored fiber cement sheet with an anthracite colored glaze, because this color reacts particularly sensitively to aging phenomena. The pigmentation corresponds to a color available on the market and is very minor, such that the coating is transparent and thus displays the most extreme aging behavior.

Formulation 1 contains only the hydrophilic pure acrylate as a binding agent, and a hydrophilic hardener, as well as an inorganic filler material. With this formulation, one obtains bubble formation after a warm water and freezing test, as well as a strong fading in the moisture test (evaluation: 5V).

In formulation 2, a portion of the hydrophilic pure acrylate binding agent is replaced by hydrophobic styrene acrylate. As a result, the bubbles disappeared in the freezing test.

In formulation 3, additionally, half of the hydrophilic hardener Bayhydur 304 was replaced by the hydrophobic hardener Desmodur N-3600, and half of the inorganic filler material Plastorit was replaced by the organic filler material Decosoft 15. In comparison with formulation 2, the bubble formation disappeared in the warm water test, and the discoloration disappeared in the moisture test. In addition, the UV resistance improved (lower color change AE) and the degree of gloss was reduced by more than half.

Formulation 4, lastly, contained, as proposed according to the invention, a mixture of the two OH-functionalized polyacrylate binding agents, the mixture of the two isocyanate hardeners, and a mixture of the organic filler materials Decosoft 15 and Decosoft 18, having different average grain sizes. As demanded in accordance with the objective, the coating according to formulation 4 had the lowest gloss degree, meaning a matt coating to the greatest possible extent, with a very good moisture, warm water, freezing/thawing and UV resistance.

The UV resistance can, lastly, be optimized by means of a combination of the two Tinuvin UV protective agents, resulting in an optimal protection against UV radiation, which can lead to cloudiness in the coatings and layer structure.

With the following spectrums and tables, the importance of a complete hardening of the 2K-PUR coating by means of thermal effects is to be shown:

Image 1: Tracking of the cros slinking reaction via measurement of the isocyanate band at 2269 cm⁻¹ (arrow).

The arrow indicates the isocyanate band at 2269 cm⁻¹ in a 2K-PUR film according to the invention, which has been applied to Eternit fiber cement. The isocyanate band at 2269 cm⁻¹ was tracked in both spectrum rows at regular time intervals between 0 hours after the application (uppermost measurement) and 14 days (lowermost measurement).

Spectrum A: crosslinking reaction after 20 minutes, 80° C., after which it is stored at room temperature

The isocyanate band at 2269 cm⁻¹ is still not fully reacted even after 14 days (lowermost spectrum) at room temperature (measured with an ATR-FT-IR Spectrometer 100 from Perkin Elmer).

Spectrum B: crosslinking reaction after 100 minutes, 80° C.

The isocyanate band at 2269 cm⁻¹ is already fully reacted at time 0 (uppermost spectrum) after 100 minutes of hardening at 80° C. (measured with an ATR-FT-IR Spectrometer 100 from Perkin Elmer).

TABLE 3
comparison of the resistances of the 2K-PUR coating
on anthracite colored fiber cement substrate

| | 2K-PUR coating | 2K-PUR coating |
|---|---|---|
| | after incomplete | after complete |
| | drying (20 | drying (100 |
| | minutes, 80° C.) | minutes, 80° C.) |
| Stripping 0-test | 1 | 0 |
| Warm water test | 2V | 0-1 |
| Stripping after | 1 | 0 |
| warm water test | | |
| Moisture test | 3V | 0-1 |
| Stripping after | 0 | 0 |
| moisture test | | |
| Freezing test | 2V | 0-1 |
| Stripping after | 0 | 0 |
| freezing test | | |
| ΔE after | 5.58 | 1.69 |
| 2000 hours QUV | | |

Evaluation scale:
0 = excellent, 1 = very good, 2 = good, 3 = moderate, 4 = poor, 5 = very poor
V = discoloration

### Commentary:

The incompletely hardened 2K-PUR film displays obvious discoloration/fading (V) in the warm water, moisture and freezing tests, which is not the case with the fully hardened film. In addition, in the QUV test, which indicates the aging as a result of UV radiation, the fading with a AE, after 2000 hours, of 5.58 is unacceptably high, while the fully hardened film, having a AE of 1.69, exhibits a very good resistance.

### Example of an Application Process:

The following process is carried out on a fiber cement raw sheet from the company Eternit, in Niederurnen, Switzerland, which has been made hydrophobic with a silane, which causes water repellency, in advance, by means of a calender application:

In a first step, 20-30 g/m² of a primer, consisting of a pure acrylate dispersion, is applied to the fiber cement sheet by means of a calender. Subsequently, the fiber cement sheet is heated to 40-50° C. surface temperature, and the primer is dried. The back surface coating, consisting of a mixture of wax dispersions having a wet film application quantity of 25-40g/m², is applied, also by means of a calender, onto the back surface of the sheet, which is still heated to the same temperature. After 1-5 minutes drying time, at approx. 30°-70° C., the three components (glaze=component A, hardener=component B, and water, for diluting purposes, =component C) of the 2K-PUR composition according to the invention are dosed and homogeneously mixed in a defined mixture ratio by means of a dosing and mixing assembly, which doses and mixes the 2K-PUR composition by means of two static mixers. The aqueous 2K-PUR coating is sprayed on by means of spray guns. The mixing ratio of components A, containing binding agents, fillers and additives, and B, containing the hardener mixture, is, depending on the class of color, A:B=4:1 to 8:1, preferably 6:1. The mixture, consisting of A and B, is subsequently, if necessary, diluted with water, up to 25%. The wet film thickness is 140-220 g/m². After 5 minutes drying time, the film is heated to 60° C. for approx. 2 minutes, in order to obtain a filming, and subsequently hardened for 100-140 minutes at 65-85° C. ATR FT-IR recordings of the film hardened in this manner show that the isocyanate band at 2269 cm⁻¹ has disappeared, and thus, the 2K-PUR film is actually fully hardened (FIG. 1). The sheet is thus finished and in the delivery state.

The gloss degree of the hardened coating, measured with a gloss degree measuring device, at a measurement angle of 85°, is less than 10% (DIN/EN13300).

The weather resistance is determined by means of the following tests: on one hand, by means of an internally defined test for freezing/thawing cycles (test samples are tested with the coated side up: freezing in approx. 10 min., maintained at −25° C. for 50 min., and subsequently thawed by means of water for 50 min. at room temperature; prior to the next freezing cycle, the water is drained off; testing period: 36 cycles), QUV test (8 hours irradiation with 1.15 Watt/m² at 60±3° C., 4 hours thawing at 60 ±3° C., duration: 4000 hours), 4000 hours xenon testing according to an ASTM ASTM G 26-70, DIN 53387, moisture test according to an ASTM 2366 (4 days, 60° C., in the steam phase above a steam bath at 65° C., evaluated after subsequent drying) and a warm water test (test sample is placed in 40° C. warm water for 4 days).

After the tests, the test samples are re-dried over night at 80±10° C., and subsequently, on one hand, the optical appearance is evaluated in comparison with a reference sample (color changes, spotting, cloudiness, efflorescence, bubbles, erosion, chalking, flaking, cracks, etc.), and on the other hand, the bonding is evaluated. The bonding is tested in that a stripping test is executed by means of an adhesive tape (Tesaband No. 4651, from the company Biersdorf).

The examples described above and the data according to the invention relate, of course, to examples for a better understanding of the present invention. The invention is by no means limited to the recipes specified by way of example, and any suitable OH-functionalized binding agent, such as the specified polyacrylates and styrene acrylates, in particular, as well as aliphatic isocyanate hardeners are suitable binding agent components. The proposed recipes are also suitable for coating, in addition to the specified fiber cement sheets, concrete, cement bonded construction materials of any kind, with or without fiber reinforcement, cement composites, clay, wood, etc., for the coating of a substrate consisting at least in part of a mineral substance. According to the present invention, it is proposed, in particular, that at least one filler material having an organic base, such as polyurethane or polymethyl methacrylate, be used in addition to the specified binding agent.

1. A composition for the coating of a substrate, consisting at least in part of mineral materials, containing a formulation having at least two components, characterized by
a first component, with a base having at least one OH-functionalized binding agent, such as at least one polyacrylate having a styrene content of approx. ≦30%,
a second component, containing at least one aliphatic isocyanate or a polymer thereof, and at least one filler substance having an organic base, such as polyurethane or polymethyl methacrylate.

2. The composition according to claim 1, characterized in that the first component is present as a dispersion of at least one polyacrylate and/or styrene acrylate and/or mixtures thereof.

3. The composition according to claim 1, characterized in that there are mixtures of polyacrylate in the first component, wherein one component has a styrene content of approx. ≦30% and at least one second component has a styrene content of approx. ≦5% and/or is an OH-functionalized pure acrylate.

4. The composition according to claim 1, characterized in that the first component contains, in addition to the binding agent and pigments, further raw substances and auxiliary substances, selected from the list of:
filler substances, crosslinking and dispersion additives, emulsifying agents, rheology additives, wetting and flow additives, defoaming agents, storage and film preservatives, wax dispersions, hydrophobing agents, biocides, UV protection agents, fibers, solvents, film-forming agents and other raw materials, as well as mixtures thereof.

5. The composition according to claim 1, characterized in that at least two filler materials having a polyurethane and/or polyacrylate base are present, having different average grain sizes of approx. 10-20 μm, and approx. 15-25 μm.

6. The composition according to claim 1, characterized in that, in addition, an inorganic filler is present.

7. The composition according to claim 1, characterized in that UV absorbers having a triazine base are present.

8. The composition according to claim 1, characterized in that the second component of the formulation contains oligomers/polymers of the monomer aliphatic isocyanate, such as hexamethylene di-isocyanate and/or oligomers/polymers from isophorone di-isocyanates as hardener components, which, optionally, may be modified by means of ethylene oxide and/or propylene oxide and/or 3-(cyclohexylamino)-1-propane-sufonic acid.

9. The composition according to claim 8, characterized in that a mixture of hardeners is present as the hardener component, wherein one hardener is more hydrophilic, and another hardener is more hydrophobic.

10. The composition according to claim 1, characterized in that at least one aliphatic hardener, having a hexamethylene di-isocyanate base and/or one modified hexamethylene di-isocyanate, such as polyether allophanate modified hexamethylene di-isocyanate, is present as a hardener component.

11. The composition according to claim 1, characterized in that the isocyanate content of the hardener is between 10-40%, or 5-25%.

12. The composition according to claim 8, characterized in that the ratio of the first binding agent component of the formulation for hardener components amounts to a molar ratio of [OH] to [NCO] equal to 1:1-1:5, such as 1:1.5, for example.

13. A method for the production of a composition for the coating of a substrate, consisting at least in part of mineral materials, containing a formulation having at least two components, characterized in that one first component, with a base of at least one OH-functionalized binding agent, and one second component, containing at least one aliphatic isocyanate or an oligomer or a polymer thereof, are mixed together in a molar ratio of [OH] to [NCO] at a ratio of 1:1-1:5, wherein, prior to, or during the mixing of the two components, at least one mixture of filler materials having an organic base, such as polyurethane or polymethyl methacrylate, is added, or mixed in, wherein said filler materials have different grain sizes.

14. The method according to claim 13, characterized in that a dispersion of a mixture of a polyacrylate having a styrene content of approx. ≦30%, with another polyacrylate having a styrene content of approx. ≦5% and/or an OH-functionalized pure acrylate, is mixed with a mixture of at least two aliphatic isocyanate hardeners for the first component, wherein at least one hardener is hydrophilic, and one other hardener is hydrophobic, and in that, additionally, fillers having an organic base, such as polyurethane or polymethyl methacrylate, said fillers having different grain sizes, as well as UV absorber additives, having a triazine base, are added to the first component.

15. The method according to claim 13, characterized in that the mixing of the components is carried out by means of automated mixing and dosing methods.

16. A method for coating a mineral substrate such as a fiber cement sheet, using a composition according to claim 1, characterized in that the mineral substrate is made hydrophobic by means of a primer, prior to the coating.

17. The method according to claim 16, characterized in that the mineral substrate is heated prior to the application, or coating, respectively, of the composition, to a surface temperature of 25°-80°, for example, preferably to 40°-50°.

18. The method according to claim 15, characterized in that the coating, after the application on the mineral substrate, is thermally treated for a complete reaction of the components, over at least 10 minutes, in a temperature range of 20°-120°, for example, over the course of preferably 100 minutes, in a temperature range of 65°-85°, for example.
